(19) United States
(12) Patent Application Publication
(10) Pub. No.: US 2010/0136248 A1
(43) Pub. Date: Jun. 3, 2010

(54) METHOD OF MANUFACTURING AND PROCESSING SILICON CARBIDE SCANNING AND OPTICAL MIRRORS

(75) Inventor: Stephen Hastings, Munchen (DE)

Correspondence Address: FRASER CLEMENS MARTIN & MILLER LLC, 28366 KENSINGTON LANE, PERRYSBURG, OH, 43551, US

(73) Assignee: OPTOSIC AG, Baden-Baden (DE)

(21) Appl. No.: 11/993,702

(22) PCT Filed: Oct. 30, 2007
(86) PCT No.: PCT/EP2007/061693

§ 371 Date: Feb. 12, 2010

(30) Foreign Application Priority Data
Aug. 20, 2007 (EP) PCT/EP07/58615

(51) Int. Cl. C23C 4/00; C23C 4/10; C23C 4/18; C23C 4/02; G02B 5/08

(52) U.S. Cl. 427/450; 427/162; 427/446

(57) ABSTRACT

The invention relates to a method of Silicon Carbide scanning or optical mirror production. In order to reduce the costs for manufacturing a scanning or optical mirror, according to the present invention, Silicon Carbide powder is pressed or stamped or isostatically pressed using an engineered stamp or tool to form the shape and structure of a scanning or optical mirror which is then in this embodiment sintered to provide a surface that will become the face surface of said scanning or optical mirror that is then coated or bonded with a suitably thick layer of in this embodiment Silicon material deposited by a thermal spray process onto said face surface of said scanning or optical mirror that is then polished to achieve the desired surface quality and/or roughness and/or flatness and then optical coated using coating technologies and materials to coat said face surface that will then become the reflective surface with suitable high reflective optical coatings specific to the wavelength or wavelengths that the finished Silicon Carbide scanning or optical mirrors will be used to reflect in final application/s.

### FIELD OF THE INVENTION

This invention relates to a method of manufacturing and processing of Silicon Carbide scanning or optical mirrors. In addition, the invention relates to the method to achieve low cost production and high quality surface finishes on Silicon Carbide scanning or optical mirrors using available isostatic pressing, sintering and polishing techniques by depositing or bonding an alternative material on said Silicon Carbide scanning or optical mirrors, eg. Silicon, and subsequently using said available polishing techniques to polish said alternative material instead of directly polishing the Silicon Carbide material.

### BACKGROUND OF THE INVENTION

Traditional Silicon Carbide scanning or optical mirror manufacturing is limited by several factors:

Firstly, and because Silicon Carbide is a material with an extremely high mechanical hardness it is significantly expensive and time consuming to manufacture as scanning or optical mirrors when the Silicon Carbide powder is pre-pressed or pre-isostatically pressed and then engineered or Computer Numerical Control engineered and then treated or sintered.

Secondly, and because Silicon Carbide is a material with an extremely high mechanical hardness it is significantly expensive and difficult to polish to industrially required flatness with good cost-efficiencies.

Thirdly, because said Silicon Carbide has such said extremely high mechanical hardness, when manufactured for use as for example plano scanning or optical mirrors the surface that will eventually become the reflective surface is required to be produced as flat as possible in preparation for lapping and/or polishing using grinding technology and commonly diamond wheel grinding.

Fourth, because said grinding and commonly diamond wheel grinding can achieve planarity of said example piano Silicon Carbide scanning or optical mirrors depending upon the positional accuracy of said grinding technology said planarity achieved is cost-relative to the said positional accuracy of said grinding technology.

Fifth, because said Silicon Carbide has such said extremely high mechanical hardness the polishing of said example Silicon Carbide scanning or optical mirrors may involve up to four separate lapping and/or polishing stages with greater polishing material/s wear and consumption and greater lapping and/or polishing times.

Sixth, because said Silicon Carbide has a particular surface structure, after lapping and/or polishing said surface structure will only have a surface quality of at best a Ra of 3 micrometers.

Seventh, because said surface quality of said Silicon Carbide after lapping and/or polishing will have a surface quality of at best a Ra of 3 micrometers spatial effects may limit the reflective performance of said example plano Silicon Carbide scanning or optical mirrors in applied use after final optical coating.

Eighth, because said surface quality of said Silicon Carbide after lapping and/or polishing is not generally known and quantified by the optical coating industries it is probable that testing, trials and authentication may be required to authenticate optical coatings direct onto Silicon Carbide and may also require modifications to the chemical mixture of said optical coatings.

### SUMMARY OF THE INVENTION

A method is provided for the manufacturing and processing of finished Silicon Carbide scanning or optical mirrors whereby said Silicon Carbide scanning or optical mirrors are produced by pressing or stamping or isostatically pressing Silicon Carbide powder using an engineered stamp or tool and in this embodiment then sintered and where high quality surface finishes on said Silicon Carbide scanning or optical mirrors are achieved using available polishing techniques by pre-depositing or bonding an alternative material on said Silicon Carbide scanning or optical mirrors, eg. Silicon, and subsequently using said available polishing techniques to polish said alternative material instead of directly polishing the Silicon Carbide material.

In this method the scanning or optical mirror is designed and from the design parameters a stamp or tool is then manufactured that will form the Silicon Carbide scanning or optical mirrors by pressing or stamping or isostatically pressing Silicon Carbide powder using said stamp or tool and in this embodiment then sintered.

The surface that will become the reflective surface of said scanning or optical mirror may then be ground using grinding technology and commonly diamond wheel grinding or lapped or polished using commonly available lapping or polishing technology before being coated by deposition technology and in this embodiment high velocity Oxygen fuel thermal spray process or HVOF or Cold Gas Spray deposition technology to deposit a layer of material and in this embodiment Silicon bonded to said surface of said Silicon Carbide that will become said reflective surface or bonded with and in this embodiment a wafer of suitable substrate and in this embodiment Silicon and once coated or bonded with said layer of material and in this embodiment Silicon deposited to or bonded to said surface of said Silicon Carbide that will become said reflective surface said layer of material and in this embodiment Silicon is then lapped and/or polished to the required flatness using available lapping and/or polishing techniques so that once polished to said required flatness said Silicon Carbide scanning or optical mirror now coated or bonded with a layer of material and in this embodiment Silicon on the said surface that will become said reflective surface is ready for optical coating using coating technologies and materials to coat said surface that will become said reflective surface with suitable high reflective optical coatings specific to the wavelength or wavelengths that the finished Silicon Carbide scanning or optical mirror will be used to reflect in final application/s.

Advantageously, Silicon Carbide is significantly cheaper and faster to manufacture as scanning or optical mirrors when the Silicon Carbide powder is pressed or stamped or isostatically pressed using an engineered stamp or tool and then in this embodiment sintered than when the Silicon Carbide powder is pre-pressed or pre-isostatically pressed and then engineered for example by Computer Numerical Control engineering and then treated or sintered.

Advantageously, because said layer of material and in this embodiment Silicon bonded to said surface of said Silicon Carbide that will become said reflective surface is significantly easier to lap and/or polish than the raw Silicon Carbide material of said surface without any additional layer material and in this embodiment Silicon said lapping and/or polishing is faster and cheaper.

Advantageously, because said layer of material and in this embodiment Silicon deposited on or bonded to said surface of said Silicon Carbide that will become said reflective surface is of a significantly finer structure than the raw Silicon Carbide material of said surface without any additional layer of deposited or bonded material said layer of material and in this embodiment Silicon will give a finer surface roughness and/or surface quality after lapping and/or polishing and significantly decrease reflective spatial effects in application when coated with suitable high reflective optical coatings specific to the wavelength or wavelengths that the finished Silicon Carbide scanning or optical mirror will be used to reflect in final application/s.

Advantageously, because said layer of material and in this embodiment Silicon bonded to said surface of said Silicon Carbide that will become said reflective surface is of a known and quantified material to the optical coating industries where the raw Silicon Carbide material of said surface without any additional layer of material is generally not said layer of material and in this embodiment Silicon known and quantified to the optical coating industries has known and quantified bonding to suitable high reflective optical coatings specific to the wavelength or wavelengths that the finished Silicon Carbide scanning or optical mirrors will be used to reflect in final application/s.

### BRIEF DESCRIPTION OF THE DRAWINGS

FIG. 1 is a diagram of a production flowchart depicting an ideal process flow to produce finished Silicon Carbide scanning or optical mirrors.

FIG. 2 is a simple side elevation diagram depicting a typical Silicon Carbide scanning mirror.

FIG. 3 is a simple side elevation diagram depicting deposition onto a typical Silicon Carbide scanning mirror.

FIG. 4 is a simple side elevation diagram depicting a deposited alternative material layer on a typical Silicon Carbide scanning mirror.

FIG. 5 is a simple side elevation diagram depicting optical coating onto a deposited alternative material layer on a typical Silicon Carbide scanning mirror.

### DETAILED DESCRIPTION OF THE INVENTION

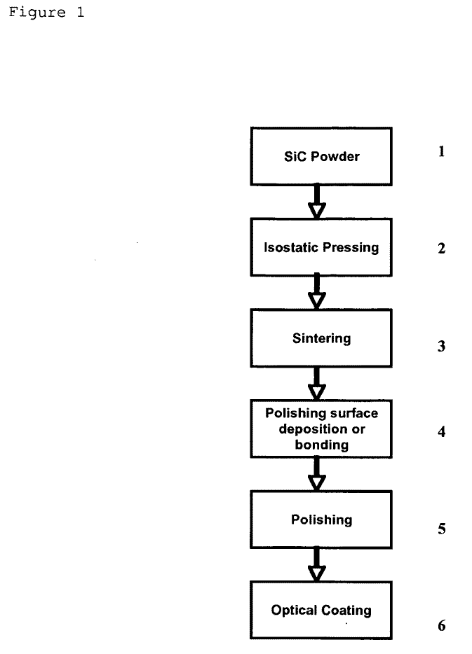

As depicted in the production process flowchart in FIG. 1, Silicon Carbide powder (1) is pressed or stamped or isostatically pressed (2) using an engineered stamp or tool to form the shape and structure of a scanning or optical mirror which is then in this embodiment sintered (3) to provide a Silicon Carbide scanning or optical mirror with a surface that is the face surface of said scanning or optical mirror that may be then ground using grinding technology and commonly diamond wheel grinding or lapped or polished (not shown) using commonly available lapping and/or polishing technology.

The Silicon Carbide scanning or optical mirror now with a surface that is the face surface of said scanning or optical mirror ground using grinding technology and commonly diamond wheel grinding or lapped or polished using commonly available lapping and/or polishing technology enters a deposition or bonding process (4) and in this embodiment high velocity Oxygen fuel thermal spray process or HVOF or Cold Gas Spray or wafer bonding to deposit or bond a suitably thick layer of alternative material and in this embodiment Silicon onto said face surface of said scanning or optical mirror.

The Silicon Carbide scanning or optical mirror now with a surface that is the face surface of said scanning or optical mirror deposited or bonded with a suitably thick layer of material and in this embodiment Silicon onto said face surface of said scanning or optical mirror enters the polishing process stage (5) where by lapping and/or polishing of said suitably thick layer of material and in this embodiment Silicon deposited on or bonded to said face surface of said scanning or optical mirror the required surface quality and/or roughness and/or flatness is achieved.

The Silicon Carbide scanning or optical mirror now with a surface that is the face surface of said scanning or optical mirror deposited or bonded with a suitably thick layer of material and in this embodiment Silicon onto said face surface of said scanning or optical mirror and further polished where by lapping and/or polishing of said suitably thick layer of material and in this embodiment Silicon deposited on or bonded to said face surface of said scanning or optical mirror so that said required surface quality and/or roughness and/or flatness is achieved by lapping and/or polishing said deposited or bonded material and in this embodiment Silicon then enters the optical coating process stage (6) where coating technologies and materials are used to coat said polished surface that post optical coating will become the reflective surface with suitable high reflective optical coatings specific to the wavelength or wavelengths that the finished Silicon Carbide scanning or optical mirror will be used to reflect in final application/s.

As depicted in FIG. 2, in this embodiment a Silicon Carbide scanning mirror (7) is manufactured with a surface (8) that is the face surface of in this embodiment said scanning mirror.

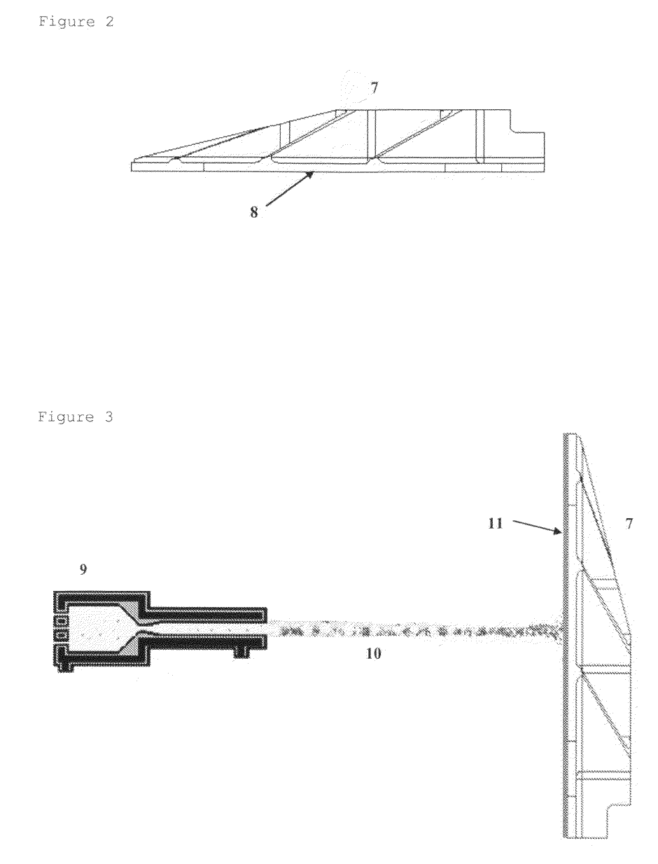

As depicted in FIG. 3, in this embodiment a Silicon Carbide scanning mirror (7) with a surface that is said face surface is deposited with a suitably thick layer of alternative material (11) onto said face surface of in this embodiment said scanning mirror (7) using deposition process equipment (9) and in this embodiment high velocity Oxygen fuel thermal spray process or HVOF or Cold Gas Spray to target deposition material (10) onto said surface of in this embodiment said Silicon Carbide scanning mirror (7).

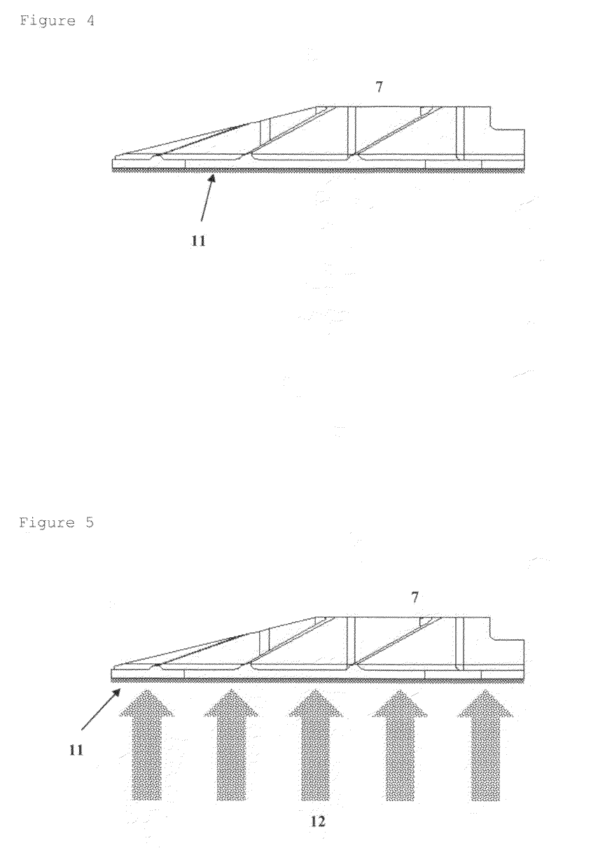

As depicted in FIG. 4, in this embodiment a Silicon Carbide scanning mirror (7) with a surface that is said face surface has now deposited onto said surface a suitably thick layer of alternative material (11) onto said surface of in this embodiment said scanning mirror (7) ready for polishing using lapping and/or polishing techniques.

As depicted in FIG. 5, in this embodiment a Silicon Carbide scanning mirror (7) with a surface that is said face surface with deposited or bonded onto said surface a suitably thick layer of material (11) and said face surface of in this embodiment said scanning mirror (7) has been polished using lapping and/or polishing techniques to produce said surface (11) to an acceptable quality, roughness and/or flatness said surface with said lapped and/or polished suitably thick layer of material (11) is then optically coated with suitable high reflective optical coatings (12) specific to the wavelength or wavelengths that the finished in this embodiment Silicon Carbide scanning mirror will be used to reflect in final application/s.

1. A method of Silicon Carbide scanning or optical mirror production whereby Silicon Carbide powder is pressed or stamped or isostatically pressed using an engineered stamp or tool to form the shape and structure of a scanning or optical mirror which is then in this embodiment sintered to provide a surface that will become the face surface of said scanning or optical mirror that is then coated or bonded with a suitably thick layer of in this embodiment Silicon material deposited by a thermal spray process onto said face surface of said scanning or optical mirror that is then polished to achieve the desired surface quality and/or roughness and/or flatness and then optical coated using coating technologies and materials to coat said face surface that will then become the reflective surface with suitable high reflective optical coatings specific to the wavelength or wavelengths that the finished Silicon Carbide scanning or optical mirrors will be used to reflect in final application/s.

2. The method as claimed in claim 1, wherein the suitably thick layer of material deposited or bonded onto the Silicon Carbide scanning or optical mirror is Silicon Dioxide.

3. The method as claimed in claim 1, wherein the suitably thick layer of material deposited or bonded onto the Silicon Carbide scanning or optical mirror is Copper.

4. The method as claimed in claim 1, wherein the suitably thick layer of material deposited or bonded onto the Silicon Carbide scanning or optical mirror is Aluminium.

5. The method as claimed in claim 1, wherein the suitably thick layer of material deposited onto the Silicon Carbide scanning or optical mirror is any suitable material.

6. The method as claimed in claims 1-5, wherein the suitably thick layer of material deposited onto the Silicon Carbide scanning or optical mirror is achieved using a high velocity Oxygen fuel spraying process or HVOF.

7. The method as claimed in claims 1-5, wherein the suitably thick layer of material deposited onto the Silicon Carbide scanning or optical mirror is achieved using a Cold Gas Spray process.

8. The method as claimed in claims 1-5, wherein the suitably thick layer of material deposited onto the Silicon Carbide scanning mirror is achieved using a low pressure plasma spraying process or LPPS.

9. The method as claimed in claims 1-5, wherein the suitably thick layer of material deposited onto the Silicon Carbide scanning or optical mirror is achieved using any deposition process.

10. The method as claimed in claims 1-5, wherein the suitably thick layer of material is a wafer of a suitable substrate bonded onto the Silicon Carbide scanning or optical mirror.

11. The method as claimed in claims 1-10, wherein the Silicon Carbide mirror is a non-scanning or static mirror.

12. The method as claimed in claims 1-11, wherein said Silicon Carbide scanning or optical mirror is manufactured by computer numerical control engineering a pre-pressed or pre-isostatically pressed block of Silicon Carbide powder.
